(19) United States
(12) Patent Application Publication
(10) Pub. No.: US 2003/0160450 A1
(43) Pub. Date: Aug. 28, 2003

(54) Fitting for a valve body and method for installing the fitting

(76) Inventor: Gene Kozak, Flanders, NJ (US)

Correspondence Address: Thomas L. Adams, 120 Edgle Rock Avenue, P.O. Box 340, East Hanover, NJ, 07936, US

(21) Appl. No.: 10/084,801

(22) Filed: Feb. 28, 2002

(51) Int. Cl. F16L 17/00

(52) U.S. Cl. 285/353

(57) ABSTRACT

A valve assembly includes alternate tubular fittings and a valve body. A selected tubular fitting is open at both ends and has an interval with external threads. This interval includes distal external threads and proximal external threads on opposite sides of a predetermined axial position on the fitting. The valve body has a bore with a mouth that is at least partially pre-tapped with internal body threads independently of the fitting. The proximal threads are sized to threadably engage the internal body threads in the valve body. The distal external threads (a) have substantially lower crests than threads located proximally from the predetermined position, (b) are sized to pass through the at least one bore without threading onto the internal body threads, and (c) are sized to thread into and modify the bore at a location deeper than the internal body threads by self-tapping. The distal external threads pass by the internal body threads without fully threading onto them.

### BACKGROUND OF THE INVENTION

1. Field of the Invention

The present invention relates to fittings for a valve body and methods for threadably installing such fittings.

2. Description of Related Art

Valve bodies made of relatively soft materials such as plastic can be easier and less costly to manufacture. Installing a fitting, such as a compression fitting, into a plastic valve body can be difficult, however. The fitting can be tightened just so much before the plastic material is excessively deformed and leaks. Also, repeated removals and installations of the fitting will further deform the internal threads of the valve body, thereby making leaking past those threads more likely.

One might attempt to install a metal tubular fitting into a valve body, and then install the compression fitting into the metal tubular fitting. While this deals with the leakage around the compression fitting, leakage around the tubular metal fitting is still a problem.

One reason why leakage occurs past threads is that a pre-tapped bore does not precisely match the threads of a later-inserted threaded body. On the other hand, self-tapping threads will ensure a precise match that reduces leakage, but will use a thread profile that is less strong and reliable. Furthermore, over-tightening a self-tapping thread will cause deformations that increase the likelihood of leakage.

In U.S. Pat. No. 4,661,031 a bolt having two threaded sections with substantially the same crest diameter and pitch is used as a fastener, not as a tubular fitting for a valve body. Regardless, the proximal section has threads lead or lag the distal section in order to preload the threads with either tensile or compressive forces. This mismatch would tend to produce leakage around the threads. In this design, the beginning threads of the proximal section are smaller, to distribute the preload forces over a greater length. This reference teaches using all of the threads of the proximal and distal sections in succession to engage the initial threads in the body receiving the bolt. Thus the threads of the proximal and distal sections are not strongly differentiated and will not produce different specialized effects for preventing leakage.

In U.S. Pat. No. 4,258,607 another non-tubular bolt has a distal and a proximal section containing threads with the same pitch. These two sections are separated by slightly more than an integer multiple of the pitch, which would tend to promote leakage. The distal section of threads is self-tapping and has threads with a wedge ramp. The threads of the proximal section have ordinary threads, but they will tend to ride out of the valleys formed by the distal section to make the bolt self-locking and vibration proof. Again, all of the threads of the proximal and distal sections engage in succession the initial threads in the body receiving the bolt and are not strongly differentiated to provide a strong, leak-proof seal.

In U.S. Pat. Nos. 5,259,398, and 5,593,410 a prosthesis screw has a distal section 24 with three starts adjacent to a proximal section with larger threads 26 having the same pitch as each of the starts of the distal section. All of these threads are self-tapping and therefore are not as strongly differentiated as might be needed to avoid leakage. Furthermore, this reference is concerned with a prosthesis screw, not a tubular fitting for a valve body. See also U.S. Pat. Nos. 4,995,810; 5,527,183; and 5,961,524.

See also U.S. Pat. No. 6,001,101 (bone screw has a self-tapping, distal section and a larger, self-tapping, proximal section with a smaller pitch).

In U.S. Pat. No. 4,729,583 an internal fitting has coarse threads on one end, and on the other end, finer pitch threads at a larger diameter. The coarse threads fit into the convolutions inside a hose. The fine threads thread into an external fitting. See also U.S. Pat. Nos. 5,292,156, and 5,794,986.

For a compression fitting, see U.S. Pat. No. 5,725,259. See also U.S. Pat. Nos. 4,109,869, and 5,934,269.

Accordingly, there is indeed for the fitting that will provide a strong and leak-free connection to valve bodies that may be formed of various materials, including plastics.

### SUMMARY OF THE INVENTION

In accordance with the illustrative embodiments demonstrating features and advantages of the present invention, there is provided a fitting for a valve body having at least one bore with a mouth that is at least partially pre-tapped with internal body threads. The fitting includes a tubular member open at both ends and having a distal end adapted to be inserted into the at least one bore. This tubular member also has an interval with external threads. This interval includes distal external threads and proximal external threads on opposite sides of a predetermined axial position on the tubular member. The distal and the proximal threads having substantially the same pitch. The proximal threads are sized to threadably engage the internal body threads in the valve body. The external threads in the interval located distally from the predetermined axial position (a) have substantially lower crests than threads located proximally from the predetermined position, and (b) are sized to pass through the at least one bore without fully engaging the internal body threads.

In accordance with another aspect of the present invention, a valve assembly is provided and includes a tubular fitting and a valve body. The tubular fitting is open at both ends and has an interval with external threads. The interval includes distal external threads and proximal external threads on opposite sides of a predetermined axial position on the fitting. The valve body has at least one bore with a mouth that is at least partially pre-tapped with internal body threads independently of the fitting. The fitting has a distal end inserted into the at least one bore of the valve body. The proximal threads are sized to threadably engage the internal body threads in the valve body. The external threads in the interval located distally from the predetermined axial position (a) have substantially lower crests than threads located proximally from the predetermined position, (b) are sized to pass through the at least one bore without threading onto the internal body threads, and (c) are sized to thread into and modify the bore at a location deeper than the internal body threads.

A method in accordance with yet another aspect of the present invention can thread into a bore of a valve body a tubular fitting having proximal external threads and distal external threads with lower crests. The method includes the step of pre-tapping at least partially the mouth of the bore with internal body threads independently of the fitting. Another step is inserting the end of the fitting having the distal external threads into the bore. The method also includes the step of passing the distal external threads past the internal body threads without fully threading the distal external threads onto the internal body threads. Another step is engaging the internal body threads with the proximal external threads. The method also includes the step of engaging and modifying the at least one bore with the distal external threads.

A method in accordance with still yet another aspect of the present invention involves threading into a bore of a valve body, alternate tubular fittings. These alternate fittings include one or more of (a) a first fitting having proximal external threads and a distal end with distal external threads with lower crests, or (b) a second fitting having a threaded distal end and a proximal end with annular teeth sized to fit into and hold onto an elastomeric tube. The method includes the step of selecting at least one of the first or the second fitting. Another step is inserting and threading the distal end of the selected one of the first or second fittings into the bore. The method also includes the step of attaching a length of tubing to the selected one of the first or second fittings.

By employing apparatus and methods of the foregoing type, fittings may be installed in a valve body while maintaining a relatively strong, reliable, and leak-free connection. In a preferred embodiment, a bore in a valve body is partially pre-tapped at the mouth of the bore. A preferred tubular fitting has a distal section of self-tapping threads that will pass by the pre-tapped threads in the valve body. Next to the distal section of self-tapping threads on the fitting is a proximal section of taller threads that are designed to engage the pre-tapped threads in the valve body.

The taller proximal threads are relatively strong and can be tightened more than shorter threads. Also, these taller proximal threads can urge the distal self-tapping threads inwardly and offer reinforcement against pulling forces. On the other hand, the self-tapping threads form an intimate seal that reduces the likelihood of leakage.

One preferred fitting will be metal and have internal chambers and threads appropriate for compression fittings.

In one highly preferred embodiment, the distal tip of the tubular fitting will have a relatively narrow annular peak designed to dig into and deform an internal surface of the valve body to form a tight seal. An annular valley next to the peak serves as a well for receiving material displaced by the peak. The distal tip of the tubular fitting will also have a relatively broad, flat surface that acts as a stop to limit the depth of penetration of the aforementioned peak.

### BRIEF DESCRIPTION OF THE DRAWINGS

The above brief description as well as other objects, features and advantages of the present invention will be more fully appreciated by reference to the following detailed description of presently preferred but nonetheless illustrative embodiments in accordance with the present invention when taken in conjunction with the accompanying drawings, wherein:

FIG. 1 is an exploded perspective view of a valve assembly having a fitting installed in a valve body, in accordance with principles of the present invention;

FIG. 2 is an axial sectional view of one of the bores of the valve body of FIG. 1, shown without a fitting;

FIG. 3 is an axial sectional view of the bore of FIG. 2, shown with a fitting installed;

FIG. 4 is a detailed sectional view of the distal end of the fitting of FIG. 3, shown engaging a wall of the valve body;

FIG. 5 is a detailed sectional view of the distal threads of the fitting of FIG. 4; and

FIG. 6 is an end view of the distal end of the fitting of FIG. 3.

### DETAILED DESCRIPTION OF THE PREFERRED EMBODIMENTS

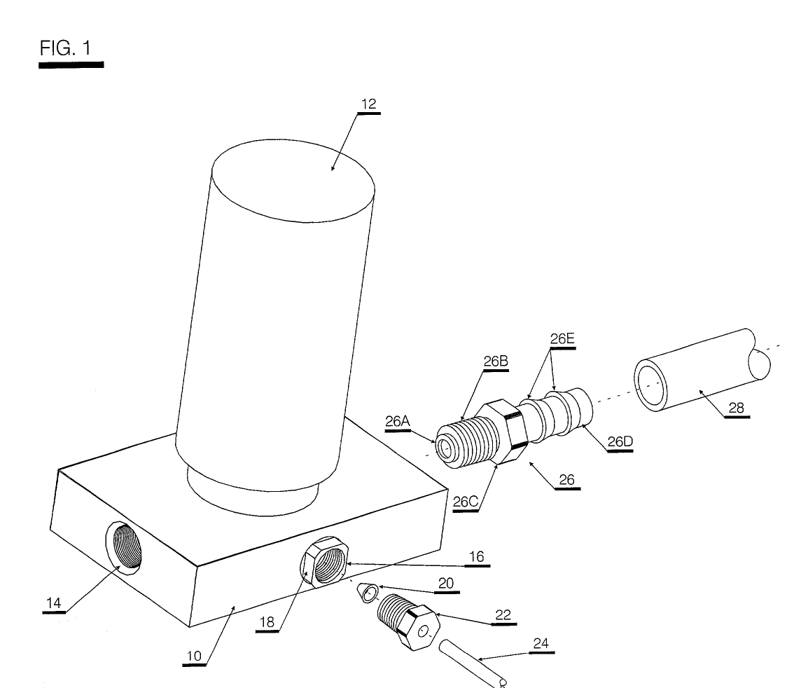

Referring to FIG. 1, the illustrated valve assembly may be a solenoid-controlled three-way valve having an electromagnetic solenoid assembly 12 mounted on a valve body 10. The valve assembly may be a precision device of the type used in medical laboratory equipment. The solenoid assembly 12 may reciprocate a poppet (not shown) mounted between assembly 12 and valve body 10, although a variety of different valve mechanisms may be employed without departing from the scope of the present invention.

Valve body 10 is a rectangular plastic block with three identical bores: a left bore 14 (visible and open in this view), a front bore fitted with a tubular fitting 16, and a right bore (not visible in this view). Fitting 16 may be threaded into the front bore using a wrench (not shown) that engages one of the four flats 18 on the exposed end of the fitting 16.

As described further hereinafter, fitting 16 is adapted to receive a conventional annular compression cone 20 and compression collar 22. In a well-known manner, one end of a length of tubing 24 is inserted through collar 22 and into compression cone 20. Cone 20 with tubing 24 inside is inserted into a conical cavity in fitting 16, as will be shown in greater detail hereinafter. Thereafter, collar 22 is threaded into fitting 16 to compress cone 20 to form a seal between fitting 16 and tubing 24.

Normally, similar fittings will be installed into each of the bores of valve body 10. For illustrative purposes however, an alternate (second) tubular fitting will be installed in the right bore of valve body 10. Specifically, a slip fitting 26 is shown with a tubular, threaded distal end 26B terminating in a thinner, unthreaded tip 26A. An integral hex collar 26C is located between threaded distal end 26B and tubular proximal end 26D, which is formed with several annular teeth 26E. Teeth 26E each have a conical proximal face that provides a ramp to allow elastomeric tube 28 to slip over the teeth. The distal faces of teeth 26E are relatively steep, if not transverse to (or overhanging) the axis of fitting 26 to provide a barb-like effect that locks tube 28 onto the proximal end 26E of fitting 26.

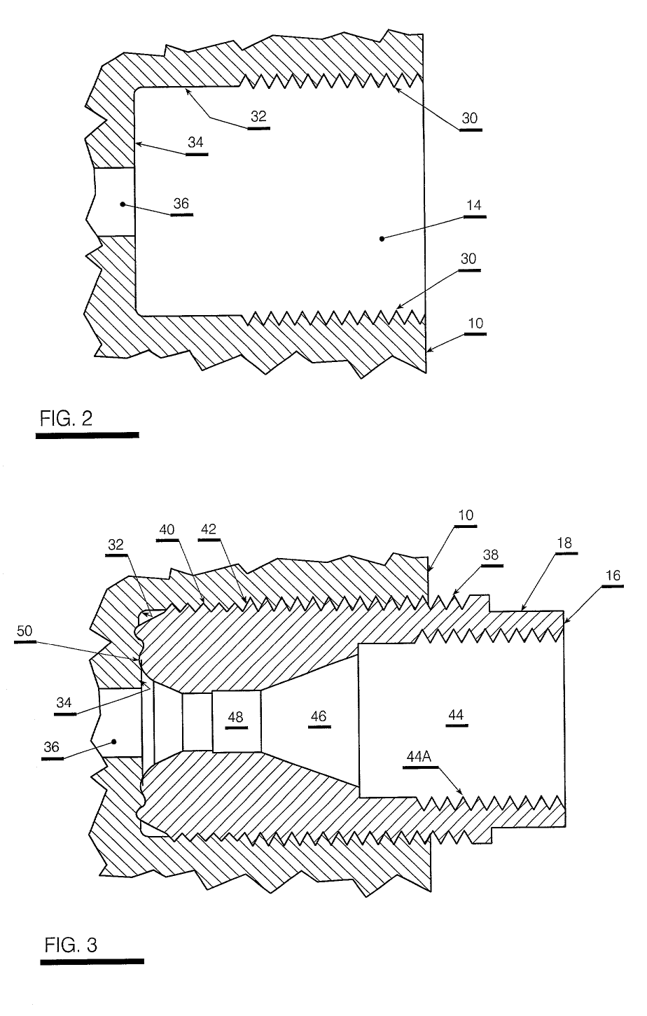

Referring to FIG. 2, previously mentioned bore 14 is shown pre-tapped with internal body threads 30 that extend from the mouth of bore 14 only part of the way through the bore. Thus, threads 30 precede an unthreaded section 32 that is adjacent to a shoulder or wall 34 in valve body 10. Wall 34 is breached by a port 36 that communicates with an internal valve mechanism (not shown).

Referring to FIGS. 3 and 6, previously mentioned fitting 16 is shown as a tubular member having an interval with external threads, namely, proximal external threads 38 and distal external threads 40. Proximal external threads 38 extend to a predetermined axial position 42 and have a greater axial length than distal external threads 40 (although different relative lengths may be employed in alternative embodiments). Also, threads 40 have lower crests than the crests of threads 42.

It is to be understood that fitting 16 is installed in a bore that is similar to that of FIG. 2. In fact, prior to installation of the fitting, the bore of FIG. 3 was identical to that shown in FIG. 2. As described further hereinafter, installation of fitting 16 will modify the bore. With this in mind, portions of the bore of FIG. 3 are marked with reference numerals identical to those used in FIG. 2.

Fitting 16 has a coaxial antechamber 44 next to a conical throat 46. Throat 46 is designed to receive the previously mentioned compression cone (cone 20 of FIG. 1). Chamber 44 has threads 44A designed to receive the previously mentioned compression collar (collar 22 of FIG. 1). Throat 46 communicates with a passage 48 that leads to the distal end 50 of fitting 16.

Referring to FIG. 4, the distal end 50 of fitting 16 is shown with an annular ridge 52 that deforms and is embedded in wall 34 of valve body 10. Ridge 52 displaces the plastic material of body 10, which is free to flow outwardly at the beveled corner 54 of fitting 16. Displaced plastic material also flows inwardly into an annular valley 56 formed in distal end 50 of fitting 16 adjacent to ridge 52. Valley 6 is located between ridge 52 and annular plateau 58, all on the distal end 50 of fitting 16.

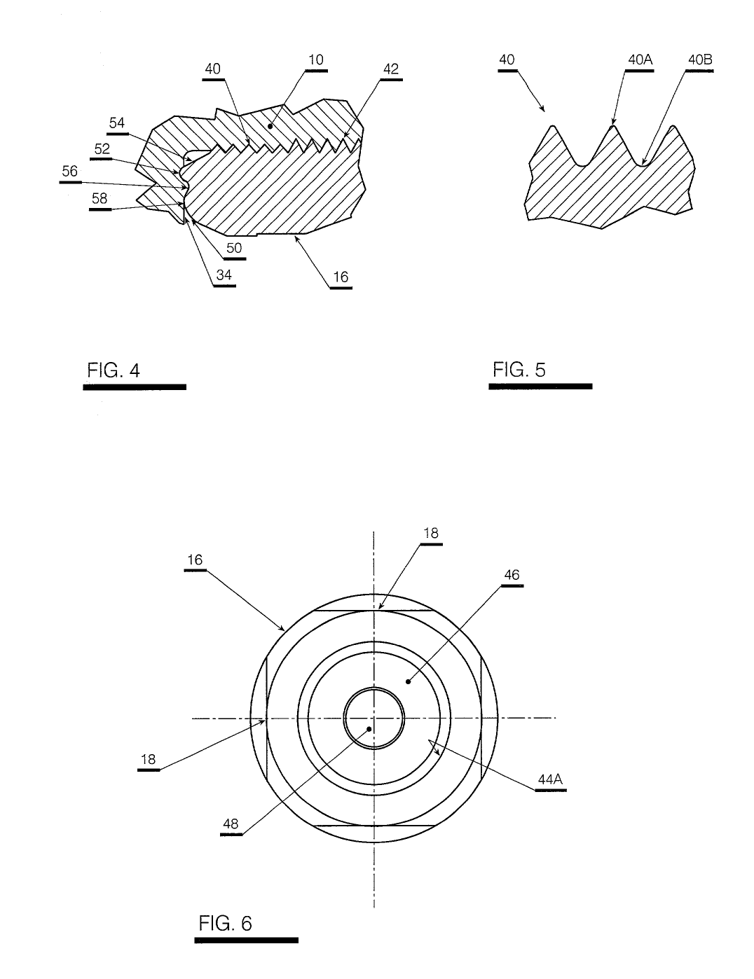

Referring to FIG. 5, previously mentioned distal threads 40 are shown with crests 40A and rounded roots 40B, which have a root diameter with a greater radius of curvature than the crests 40A. The root diameter of distal threads 40 is also greater than the root diameter of the neighboring proximal threads (threads 38 of FIG. 3). The relatively large root diameter of threads 40 are designed to facilitate self-tapping with these threads. In contrast, the neighboring proximal threads (threads 38 of FIG. 3) are non-self-tapping.

To facilitate an understanding of the principles associated with the foregoing apparatus, its operation will be briefly described. When installing the valve assembly of FIG. 1 an installer must first decide what type of coupling and fittings are desired. An advantage of the present design is that the simple plastic valve body can be adapted to oppose the number of different fitting in coupling types. I

n general the slip fittings 26 are simpler, less expensive, but less secure and less free from leakage. An installer can screw threads 26B onto threads 30 (FIG. 2) of bore 14. The narrower, unthreaded tip 26A will pass by threads 30 and reside adjacent unthreaded wall 32. Fitting 26 will be sealed by tightening it to create a tight fit between threads 30 and 26B. Thereafter, elastomeric tube 28 can be slipped over teeth 26E. Similar couplings can be achieved at the other bores of valve body 10 using similar slip fittings.

On the other hand, valve body 10 is highly adaptable and can accept metal compression fittings. In that case, fitting 16 is inserted into a bore that is pre-tapped as shown in FIG. 2. When fitting 16 is initially inserted, distal threads 40 pass by threads 30. Eventually, proximal threads 38 of fitting 16 engage threads 38 of bore 14.

The installer will continue to screw fitting 16 inwardly by placing a wrench (not shown) on the flats 18. Eventually, distal threads 40 will reach the unthreaded portion 32 of bore 14. Threads 40 will self-tap into wall 32, displacing the plastic material of valve body 10. As shown in FIG. 5, the threads 40 have relatively sharp crests 40A that will be able to dig into the plastic material and displace the plastic into the relatively large region embraced by rounded roots 40B. This self-tapping action will be reinforced by the urging of the larger proximal threads 42. Larger threads 42 will provide a greater ultimate force, although these threads will exhibit small gaps that reduce their sealing capabilities. On the other hand, self-tapping threads 40 will deform wall 32 so that effectively no gaps exist at these threads and therefore leakage will be very unlikely.

As the fitting 16 is fully screwed into place, annular ridge 52 will penetrate and deform wall 34 of valve body 10. Accordingly, material will be displaced outwardly past the beveled corner 54, and inwardly into annular valley 56. Ridge 52 will dig into wall 34 until annular plateau 58 abuts wall 34 to act as a stop. The deformation of the plastic material around ridge 52 and valley 56 will create a very tight and secure seal to prevent leakage.

It is appreciated that various modifications may be implemented with respect to the above described, preferred embodiment. While slip fittings and compression fittings are illustrated, other types of couplings may be employed instead. Furthermore, the size and upper portions of the illustrated fittings can be altered depending upon the desired capacity, tubing size, strength, reliability etc. In addition, the illustrated threads can be altered to have a different thread profile, pitch, root diameter, and crest height and diameter. Also the valve body and fittings can be made of a variety of materials, including plastics, metals, etc.

Obviously, many modifications and variations of the present invention are possible in light of the above teachings. It is therefore to be understood that within the scope of the appended claims, the invention may be practiced otherwise than as specifically described.

1. A fitting for a valve body having at least one bore with a mouth that is at least partially pre-tapped with internal body threads, said fitting comprising:
a tubular member open at both ends and having a distal end adapted to be inserted into said at least one bore, said tubular member having an interval with external threads, said interval including distal external threads and proximal external threads on opposite sides of a predetermined axial position on said tubular member, said distal and said proximal threads having substantially the same pitch, said proximal threads being sized to threadably engage the internal body threads in said valve body, the external threads in said interval located distally from said predetermined axial position (a) having substantially lower crests than threads located proximally from said predetermined position, and (b) being sized to pass through said at least one bore without fully engaging said internal body threads.

2. A fitting according to claim 1 wherein said distal and said proximal external threads are self-tapping and non-self-tapping, respectively.

3. A fitting according to claim 1 wherein said distal external threads have a rounded root.

4. A fitting according to claim 1 wherein said distal external threads have a greater root diameter than said proximal external threads.

5. A fitting according to claim 1 wherein said distal external threads have either a chip cavity or one or more thread breaks.

6. A fitting according to claim 1 wherein said distal external threads are adapted to self-tap into plastic material.

7. A fitting according to claim 1 wherein its distal end has an axially projecting, coaxial, annular ridge adapted to engage and plastically deform said valve body.

8. A fitting according to claim 7 wherein its distal end has an annular valley coaxial with said annular ridge for receiving material plastically displaced by said annular ridge.

9. A fitting according to claim 8 wherein its distal end has an annular plateau coaxial with said annular ridge for limiting penetration of said annular ridge.

10. A fitting according to claim 1 having a proximal end opposite said distal end, said fitting having a coaxial antechamber at said proximal end, and a throat extending from said antechamber to said distal end.

11. A fitting according to claim 10 wherein said antechamber has said internal threads, said throat being tapered to receive a compression cone.

12. A fitting according to claim 11 wherein said proximal end of said tubular member has a plurality of flats adapted to receive a wrench.

13. A fitting according to claim 1 wherein said proximal external threads have an axial length exceeding that of said distal external threads.

14. A valve assembly comprising:
a tubular fitting open at both ends and having an interval with external threads, said interval including distal external threads and proximal external threads on opposite sides of a predetermined axial position on said fitting; and
a valve body having at least one bore with a mouth that is at least partially pre-tapped with internal body threads independently of said fitting, said fitting having a distal end inserted into said at least one bore of said valve body, said proximal threads being sized to threadably engage the internal body threads in said valve body, the external threads in said interval located distally from said predetermined axial position (a) having substantially lower crests than threads located proximally from said predetermined position, (b) being sized to pass through said at least one bore without threading onto said internal body threads, and (c) being sized to thread into and modify said bore at a location deeper than said internal body threads.

15. A valve assembly according to claim 14 wherein said distal and said proximal external threads have substantially the same pitch.

16. A valve assembly according to claim 14 wherein said distal and said proximal external threads are self-tapping and non-self-tapping, respectively.

17. A valve assembly according to claim 14 wherein said distal external threads have a rounded root.

18. A valve assembly according to claim 14 wherein said distal external threads have a greater root diameter than said proximal external threads.

19. A valve assembly according to claim 14 wherein said distal external threads have either a chip cavity or one or more thread breaks.

20. A valve assembly according to claim 14 wherein said distal external threads are adapted to self-tap into plastic material.

21. A valve assembly according to claim 14 wherein said valve body is adapted to threadably receive a slip fitting having a threaded distal end and a proximal end with annular teeth sized to fit and lock into an elastomeric tube, said internal body threads being sized to fully threadably engage either said slip fitting or said tubular fitting.

22. A valve assembly according to claim 14 wherein the distal end of the tubular fitting has an axially projecting, coaxial, annular ridge adapted to engage and plastically deform said valve body.

23. A valve assembly according to claim 22 wherein the distal end of said tubular fitting has an annular valley coaxial with said annular ridge for receiving material plastically displaced by said annular ridge.

24. A valve assembly according to claim 23 wherein the distal end of said tubular fitting has an annular plateau coaxial with said annular ridge for limiting penetration of said annular ridge.

25. A valve assembly according to claim 14 comprising:
a length of tubing;
a compression cone sized to encompass said tubing and fit into said bore; and
an externally threaded compression collar adapted to thread into said mouth to compress said compression cone around said tubing.

26. A valve assembly according to claim 25 wherein said tubular fitting has a proximal end opposite said distal end, said fitting having a coaxial antechamber at said proximal end, and a throat extending from said antechamber to said distal end, said antechamber having internal threads, said throat being tapered to receive said compression cone.

27. A valve assembly according to claim 26 wherein said proximal end of said tubular fitting has a plurality of flats adapted to receive a wrench.

28. A valve assembly according to claim 14 wherein said proximal external threads have an axial length exceeding that of said distal external threads.

29. A method for threading into a bore of a valve body a tubular fitting having proximal external threads and distal external threads with lower crests, comprising the steps of:
pre-tapping at least partially the mouth of said bore with internal body threads independently of said fitting;
inserting the end of the fitting having said distal external threads into said bore;
passing said distal external threads past said internal body threads without fully threading said distal external threads onto said internal body threads;
engaging said internal body threads with said proximal external threads; and
engaging and modifying said at least one bore with said distal external threads.

30. A method according to claim 29 wherein the step of engaging and modifying said at least one bore is performed by cutting threads in said bore with said tubular fitting at substantially the same pitch for threads pre-tapped in said bore independently of said fitting.

31. A method according to claim 29 wherein said distal and said proximal external threads are threaded into said bore in a self-tapping and non-self-tapping manner, respectively.

32. A method according to claim 29 wherein said tubular fitting has a distal end adjacent said distal external threads, said distal end having an axially projecting, coaxial, annular ridge, the method comprising the step of:
threading said tubular fitting into said at least one bore with sufficient force to engage and plastically deform said valve body with said annular ridge.

33. A method according to claim 32 wherein the distal end of the tubular fitting has an annular valley coaxial with said annular ridge, the step of threading said tubular fitting into said at least one bore is done with sufficient force to drive material displaced by said annular ridge into said annular valley.

34. A method according to claim 33 wherein the distal end of the tubular fitting has an annular plateau coaxial with said annular ridge, the step of threading said tubular fitting into said at least one bore is stopped in response to said annular plateau abutting an internal portion of said valve body.

35. A method according to claim 29 wherein the step of engaging and modifying said at least one bore is performed after said proximal external threads have engaged the internal body threads for a plurality of turns.

36. A method according to claim 29 comprising the steps of:
placing a compression cone around a length of tubing;
fitting said cone with said tubing into said bore; and
compressing said compression cone around said tubing with an externally threaded compression collar adapted to thread into said bore.

37. A method according to claim 29 wherein the step of engaging and modifying said at least one bore is performed while said proximal external threads engage said internal body threads and inwardly urge said distal external threads.

38. A method for threading into a bore of a valve body alternate tubular fittings including one or more of a first fitting having proximal external threads and a distal end with distal external threads with lower crests, or a second fitting having a threaded distal end and a proximal end with annular teeth sized to fit into and hold onto an elastomeric tube, comprising the steps of:
selecting at least one of the first or the second fitting;
inserting and threading the distal end of the selected one of the first or second fittings into said bore; and
attaching a length of tubing to the selected one of the first or second fittings.

39. A method according to claim 38 comprising the step of:
pre-tapping at least partially said bore with internal body threads independently of said first fitting, the step of inserting and threading the distal end comprising the steps of:
passing said distal external threads of said first fitting past said internal body threads without fully threading said distal external threads onto said internal body threads; and
engaging and modifying said bore with said distal external threads of said first fitting.

40. A valve assembly according to claim 38 wherein the step of inserting and threading the distal end comprises the steps of:
screwing said second fitting into said bore; and
slipping said length of tubing over the annular teeth to hold said tubing in place.
